(19) United States
(12) Patent Application Publication
(10) Pub. No.: US 2023/0152592 A1
(43) Pub. Date: May 18, 2023

(54) AUGMENTED REALITY DISPLAY DEVICE

(71) Applicant: SAMSUNG ELECTRONICS CO., LTD., Suwon-si (KR)

(72) Inventors: Jeonggeun YUN, Suwon-si (KR); Kyusub Kwak, Suwon-si (KR); Kyookeun Lee, Suwon-si (KR); Youngmo Jeong, Suwon-si (KR)

(73) Assignee: SAMSUNG ELECTRONICS CO., LTD., Suwon-si (KR)

(21) Appl. No.: 18/097,870

(22) Filed: Jan. 17, 2023

Related U.S. Application Data
(63) Continuation of application No. PCT/KR21/08809, filed on Jul. 9, 2021.

(30) Foreign Application Priority Data
Jul. 17, 2020 (KR) 10-2020-0089159

(51) Int. Cl. G02B 27/01; F21V 8/00

(52) U.S. Cl. CPC G02B 27/0172; G02B 6/0036; G02B 6/0058; G02B 2027/0178; G02B 2027/0123

(57) ABSTRACT

Provided is an augmented reality (AR) display device. The AR display device includes an optical engine configured to output light of a virtual image and a light guide plate including a first region that receives the light of the virtual image, a third region that outputs the light of the virtual image, and a second region that propagates the light of the virtual image input to the first region toward the third region, in which a pupil expansion grating is formed in the second region to duplicate the light of the virtual image incident to the first region into a plurality of beamlets, and in the third region, an output grating array is formed in which a plurality of small diffractive grating regions are arranged at intervals equal to or less than a size of a pupil, in which a diameter of each of the plurality of small diffractive grating regions is equal to or less than the size of the pupil.

### CROSS-REFERENCE TO RELATED APPLICATIONS

This application is a continuation of PCT International Patent Application No. PCT/KR2021/008809, filed on Jul. 9, 2021 in the Korean Intellectual Property Office (KIPO) and claims benefit of priority of Korean Patent Application No. 10-2020-0089159 filed on Jul. 17, 2020 in KI PO. The content of all of the above applications are incorporated by reference herein.

### TECHNICAL FIELD

The disclosure relates to an augmented reality (AR) display device.

### BACKGROUND

An augmented reality (AR) display device enables a user to see AR, and may include, for example, AR glasses. An AR display device includes an image generation apparatus that generates an image and an optical device that transmits the generated image to eyes. The image emitted from the image generation apparatus is transmitted to the eyes through the optical device, allowing the user to observe an AR image.

In case of the AR display device, a focus of a virtual image is located on a single plane, such that it is necessary to form the focus of the virtual image on a location of an object the user is looking at, so as to increase convenience of the user wearing the AR display device. The AR display device may implement a three-dimensional (3D) effect by providing an image rendered to have binocular disparity to eyes of an observer. Such a 3D effect using the binocular disparity is relatively easy to implement and experience among various methods capable of implementing 3D, but causes fatigue to the eyes in case of wearing for a long time. The fatigue of the eyes may occur due to mismatch in convergence angles and focal lengths between both eyes, and such mismatch is also known as vergence accommodation conflict.

### SUMMARY

The disclosure provides an AR display device capable of reducing fatigue of eyes.

The technical problems of the disclosure are not limited to the aforementioned technical features, and other unstated technical problems may be inferred from embodiments of the disclosure below.

According to an aspect of the disclosure, an augmented reality (AR) display device includes an optical engine configured to output light of a virtual image and a light guide plate including a first region that receives the light of the virtual image, a third region that outputs the light of the virtual image, and a second region that propagates the light of the virtual image input to the first region toward the third region, in which a pupil expansion grating is formed in the second region to duplicate the light of the virtual image incident to the first region into a plurality of beamlets, and in the third region, an output grating array is formed in which a plurality of small diffractive grating regions are arranged at intervals equal to or less than a size of a pupil, in which a diameter of each of the plurality of small diffractive grating regions is equal to or less than the size of the pupil.

In embodiments of the disclosure, a small diffractive grating of each of the plurality of small diffractive grating regions may include any one of a diffractive optical element, a surface relief grating, a hologram optical element, and a metasurface.

In embodiments of the disclosure, each of the plurality of small diffractive grating regions may include a circular or polygonal boundary.

In embodiments of the disclosure, a size of each of the plurality of small diffractive grating regions may be equal to or less than about 4 mm.

In embodiments of the disclosure, the plurality of small diffractive grating regions may be arranged in a hexagonal array pattern.

In embodiments of the disclosure, a small diffractive grating of each of the plurality of small diffractive grating regions may include an identical or different vector.

In embodiments of the disclosure, an input diffractive grating may be formed in the first region to couple incident light, and a sum of a grating vector of the input diffractive grating of the first region, a grating vector of the pupil expansion grating of the second region, and a grating vector of a small diffractive grating of the plurality of small diffractive grating regions may be equal to 0.

In embodiments of the disclosure, a pitch of the output grating array may be uniform.

In embodiments of the disclosure, a pitch of the output grating array may be varied.

In embodiments of the disclosure, at least some of the plurality of small diffractive grating regions may have different diameters.

In embodiments of the disclosure, the plurality of small diffractive grating regions may have larger diameters in an edge of the third region than in a center of the third region.

In embodiments of the disclosure, at least a part of the third region may overlap with the second region.

In embodiments of the disclosure, at least a region of the waveguide may be formed of a transparent material to pass light of a real scene therethrough.

In embodiments of the disclosure, the AR display device may further include a body having the optical engine and the light guide plate installed therein and configured to be wearable on a user.

In embodiments of the disclosure, the body may include a glasses frame, a goggles frame, a main body of a helmet body, and a main body of a head mounted display (HMD).

According to the disclosure, an AR display device has neither distortion of real images nor degradation of image quality of virtual images.

According to the disclosure, the AR display device may implement a large eye box and a wide field of view (FoV).

According to the disclosure, the AR display device may maintain a focus of a virtual image at all times without a separate active device, thereby enabling miniaturization, low power consumption, and low price.

According to the disclosure, the AR display device may reduce the fatigue of eyes.

According to the disclosure, the AR display device may maintain a focus at all times, thereby reducing the fatigue of the eyes.

According to the disclosure, the AR display device may maintain a focus for a virtual image at all times, thereby improving an image resolution of a light guide plate.

### BRIEF DESCRIPTION OF DRAWINGS

FIG. 1 illustrates the exterior of an augmented reality (AR) display device, according to an embodiment of the disclosure.

FIG. 2 is a plan view illustrating the AR display device of FIG. 1.

FIG. 3 is a block diagram of an AR display device according to an embodiment of the disclosure.

FIG. 4 illustrates an arrangement of an optical engine and a light guide plate, according to an embodiment of the disclosure.

FIG. 5 illustrates light propagation in a light guide plate according to an embodiment of the disclosure.

FIG. 6 shows a third region of a light guide plate according to an embodiment of the disclosure.

FIG. 7 illustrates light output in a third region of a light guide plate according to an embodiment of the disclosure.

FIG. 8 illustrates an arrangement of a small output grating region according to an embodiment of the disclosure.

FIG. 9 illustrates a relationship between a small output grating region and a pupil, according to an embodiment of the disclosure.

FIG. 10 illustrates an arrangement of a small output grating region according to an embodiment of the disclosure.

FIG. 11 shows a light beam emitted from a small output grating region and reaching a retina, according to an embodiment of the disclosure.

FIG. 12 illustrates a light beam emitted from a small output grating region and arriving at a retina when an eye moves, according to an embodiment of the disclosure.

FIG. 13 illustrates various shapes of a small output grating region according to an embodiment of the disclosure.

FIG. 14 illustrates an eye and light beams of a real image and a virtual image when a user sees a short-distance real image.

FIG. 15 illustrates an eye and light beams of a real image and a virtual image when a user sees a long-distance real image.

### DETAILED DESCRIPTION

Hereinafter, example embodiments of the disclosure will be described in detail with reference to the accompanying drawings. In the drawings, like reference numerals denote like components, and sizes of components in the drawings may be exaggerated for convenience of explanation. Meanwhile, embodiments of the disclosure to be described are merely examples, and various modifications may be made from such embodiments of the disclosure.

Although terms used in embodiments of the disclosure are selected with general terms popularly used at present under the consideration of functions in the disclosure, the terms may vary according to the intention of those of ordinary skill in the art, judicial precedents, or introduction of new technology. In addition, in a specific case, the applicant voluntarily may select terms, and in this case, the meaning of the terms may be disclosed in a corresponding description part of an embodiment of the disclosure. Thus, the terms used in herein should be defined not by the simple names of the terms but by the meaning of the terms and the contents throughout the disclosure.

Singular forms include plural forms unless apparently indicated otherwise contextually. When a portion is referred to as “comprises” a component, the portion may not exclude another component but may further include another component unless stated otherwise.

In the disclosure, ‘augmented reality (AR)’ means overlaying a virtual image generated on a computer onto a physical real-world environment or a real-world object to display one image.

In the disclosure, an ‘AR display device’ refers to a device capable of expressing ‘AR’, and may include not only AR glasses in the form of glasses worn on a user, but also a head-mounted display (HMD) or an AR helmet, etc., worn on the user. The AR display device is usefully used in an everyday life such as information search, route guidance, camera photographing, etc. An AR glasses device implementing the AR display device in the form of glasses may be worn as a fashion item and used both in indoor and outdoor activities.

In the disclosure, a ‘real scene’ refers to a scene of the real world an observer or the user sees through the AR display device, and may include real world object(s). The ‘virtual image’ is an image generated through an optical engine. The virtual image may include both a static image and a dynamic image. The virtual image may be an image which is overlaid on the real scene to show information regarding a real object in the real scene or information or a control menu, etc., regarding an operation of the AR device.

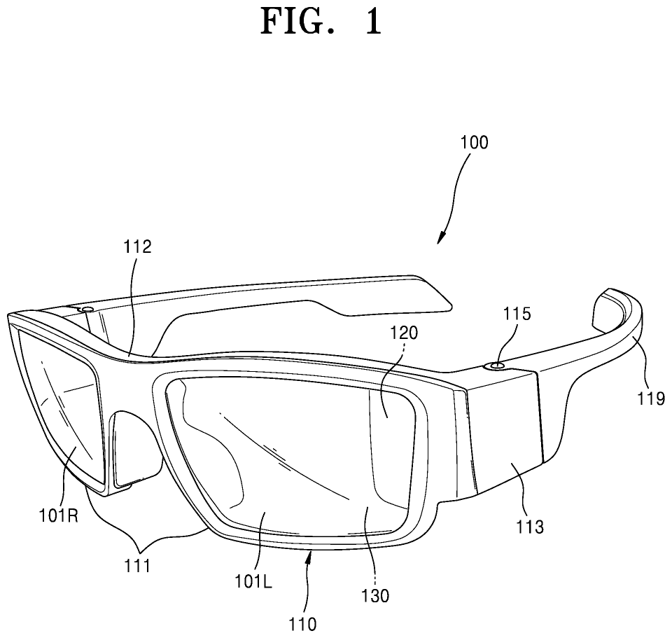

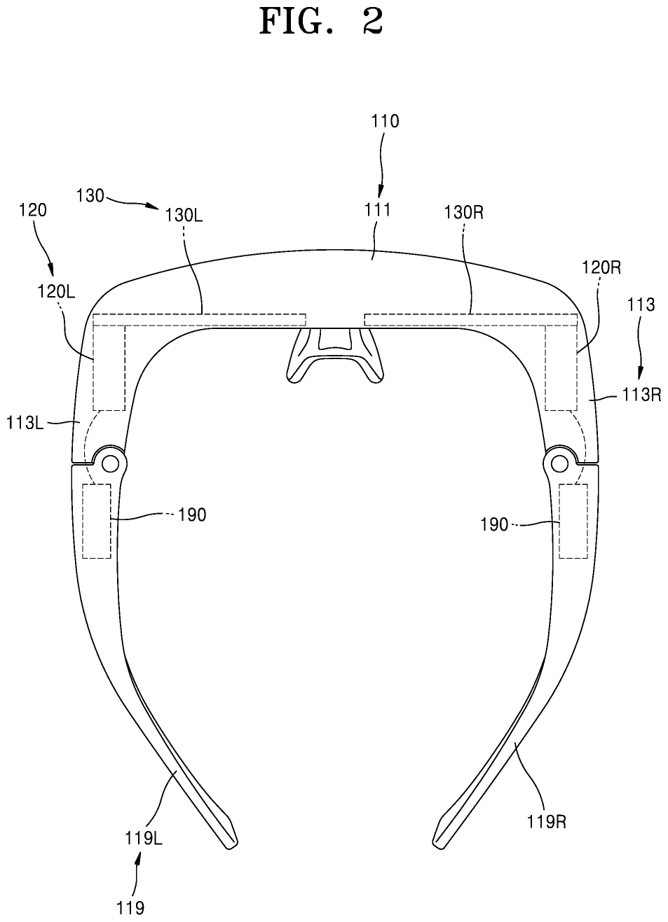

FIG. 1 illustrates the exterior of an AR display device 100 according to an embodiment of the disclosure, and FIG. 2 is a plan view of the AR device 100 of FIG. 1.

Referring to FIGS. 1 and 2, the AR display device 100 according to the current embodiment of the disclosure may be a glasses-type display device configured to be worn by the user and may include a glasses-type body 110.

The glasses-type body 110 may include, for example, a frame 111 and temples 119. The frame 111 in which glass lenses 101L and 101R are positioned may have, for example, the shape of two rims connected by a bridge. The glass lenses 101L and 101R are examples, and may have or may not have a refractive power (a power). The glass lenses 101L and 101R may be formed integrally, and in this case, the rims of the frame 111 may not be distinguished from the bridge 112. The glass lenses 101L and 101R may be omitted.

The temples 119 may be respectively connected to both ends 113 of the frame 111 and extend in a direction. The both ends 113 of the frame 111 and the temples 119 (including 119L on the left and 119R on the right) may be connected by a hinge 115. FIG. 2 illustrates end 113L on the left and end 113R on the right. The hinge 115 is an example, such that a known member connecting the both ends 113 of the frame 111 with the temples 119. In another example, the both ends 113 of the frame 111 and the temples 119 may be integrally connected.

In the glasses-type body 110, the optical engine 120, the light guide plate 130, and electronic parts 190 may be arranged. The electronic parts 190 may be mounted in a part of the glasses-type body 110 or positioned distributed in a plurality of parts thereof, and may be mounted on a printed circuit board (PCB) substrate, a flexible PCB (FPCB) substrate, etc.

The optical engine 120 may be configured to generate light of the virtual image, and may be an optical engine of a projector, which includes an image panel, an illuminating optical system, a projecting optical system, etc. The optical engine 120 may include a left-eye optical engine 120L and a right-eye optical engine 120R. The left-eye optical engine 120L and the right-eye optical engine 120R may be positioned in both ends 113 of the frame 111. In another example, the left-eye optical engine 120L and the right-eye optical engine 120R may be respectively positioned in a left temple 119L and a right temple 119R. The optical engine 120 may output polarized light or unpolarized light according to a scheme of the image panel or the illuminating optical system. For example, when the image panel is a liquid crystal on silicon (LCoS) panel or other liquid crystal image panel, or when a polarizing beam splitter is used to split/couple beams, the optical engine 120 may output linearly polarized light. In another example, when the image panel is a digital micromirror device (DMD) panel, the optical engine 120 may output unpolarized light.

The light guide plate 130 may be configured to transmit light of the virtual image generated in the optical engine 120 and light of an external scene to a pupil of the user. The light guide plate 130 may include a left-eye light guide plate 130L and a right-eye light guide plate 130R. The left-eye light guide plate 130L and the right-eye light guide plate 130R may be respectively attached to the left glass lens 101L and the right glass lens 101R. Alternatively, the left-eye light guide plate 130L and the right-eye light guide plate 130R may be fixed on the frame 111 separately from the glass lenses 101L and 101R.

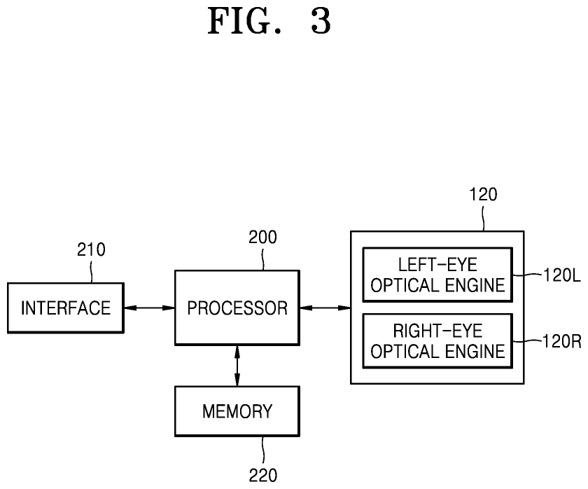

FIG. 3 is a block diagram of an AR display device according to an embodiment of the disclosure.

FIG. 3 is a block diagram of the AR display device 100 of FIG. 1. Referring to FIG. 3, the AR display device 100 may include the optical engine 120, a processor 200, an interface 210, and a memory 220.

The processor 200 may control the overall operation of the AR display device 100 including the optical engine 120 by driving an operating system or an application, and perform various data processing and operations including image data. For example, the processor 200 may process image data including a left-eye virtual image and a right-eye virtual image that are rendered to have binocular disparity. The processor 200 may include, for example, at least one hardware among a central processing unit (CPU), a microprocessor, a graphic processing unit (GPU), application specific integrated circuits (ASICs), digital signal processors (DSPs), digital signal processing devices (DSPDs), programmable logic devices (PLDs), or field programmable gate arrays (FPGAs), without being limited thereto.

Data or a manipulation command is input to or output from an outside through the interface 210 which may include a user interface, for example, a touch pad, a controller, a manipulation button, etc., which may be manipulated by the user. In an embodiment of the disclosure, the interface 210 may include a wired communication module, such as a universal serial bus (USB) module, and a wireless communication module, such as Bluetooth, through which manipulation information of the user or data of a virtual image, transmitted from an interface included in an external device, may be received.

The memory 220 may include an internal memory such as volatile memory or nonvolatile memory. The memory 220 may store various data, programs, or applications for driving and controlling the AR display device 100 and input/output signals or data of a virtual image, under control of the processor 200.

The optical engine 120 may be configured to receive image data generated by the processor 200 and generate light of a virtual image, and may include the left-eye optical engine 120L and the right-eye optical engine 120R. Each of the left-eye optical engine 120L and the right-eye optical engine 120R may include a light source that outputs light and an image panel that forms a virtual image by using the light output from the light source, and may have a function such as a small projector. The light source may be implemented as, for example, a light-emitting diode (LED), and the image panel may be implemented as, for example, a DMD.

Although left-eye optical parts 130L will be described as an example below, a left-eye part and a right-eye part have structures symmetrical to each other, such that it would be understood by those of ordinary skill in the art that the left-eye optical parts 130L may be applied to right-eye optical parts 130R.

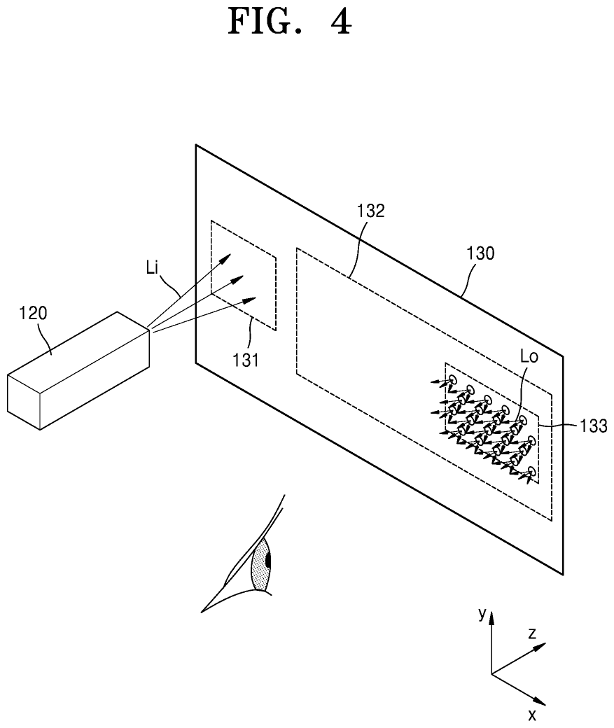

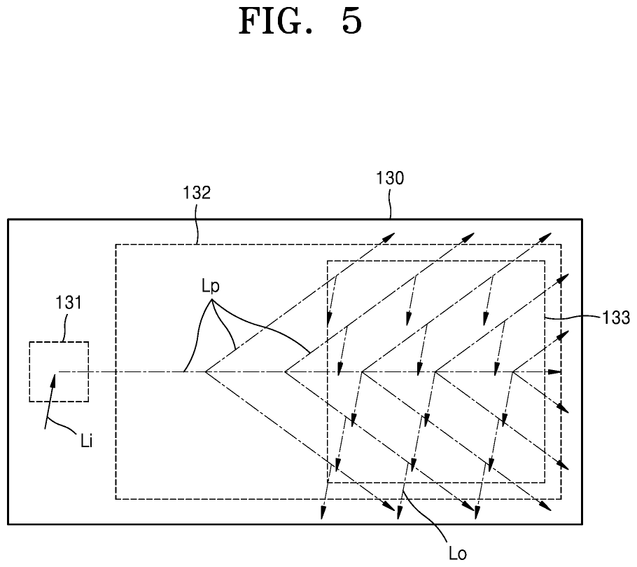

FIG. 4 illustrates arrangement of the optical engine 120 and the light guide plate 130 according to an embodiment of the disclosure, and FIG. 5 illustrates light propagation in the light guide plate 130 according to an embodiment of the disclosure. Referring to FIGS. 4 and 5, the light guide plate 130 may be formed as a single layer or multiple layers of a transparent material in which the light may propagate while being internally reflected. The light guide plate 130 may have the shape of a flat plate or a curved plate. Herein, the transparent material may refer to a material through which light in a visible light band passes, and a transparency thereof may not be 100% and the transparent material may have a certain color. The light guide plate 130 may include a first region 131 that receives light Li of a virtual image projected from the optical engine 120, facing the optical engine 120, a second region 132 to which light Lp of the virtual image incident to the first region 131 propagates while being duplicated, and a third region 133 that outputs light Lo of the virtual image propagating from the second region 132. The third region 133 that outputs the virtual image may also duplicate the virtual image.

The light guide plate 130 may be mounted on the frame 111 of FIG. 1 such that the third region 133 is positioned in front of the pupils of the user when the user wears the AR display device 100. As the light guide plate 130 is formed of a transparent material, the user may see the real scene as well as the virtual image through the AR display device 100, and thus the AR display device 100 may implement AR.

In an embodiment of the disclosure, in the first region 131 of the light guide plate 130, an input diffractive grating may be formed to couple incident light Li. When the light guide plate 130 is formed as a single layer, the input diffractive grating of the first region 131 may be formed on a surface facing the display engine 120 or an opposite surface thereto. Alternatively, when the light guide plate 130 is formed as multiple layers, the input diffractive grating of the first region 132 may be formed on each layer or some layers.

The optical engine 120 may be arranged such that the emitted light Lo is incident perpendicularly or inclinedly at a certain angle with respect to the first region 131.

The second region 132 may be positioned in a first direction (an X direction in FIG. 4) with respect to the first region 131. The second region 132 may overlap with the entire first region 131 or a part thereof. The second region 132 may be formed on the entire area of the light guide plate 130. In the second region 132, a pupil expansion grating may be formed to duplicate the light Lp of the virtual image, incident to the first region 131, into a plurality of beamlets. The pupil expansion grating may be configured to split the light Lp of the virtual image, incident to the first region 131, into a plurality of beamlets when the light Lp propagates in the light guide plate 130 through total reflection. The pupil expansion grating of the second region 132 may be configured such that the duplicated light Lp (beamlets) of the virtual image propagate across at least the entire third region 133. Such a pupil expansion grating may be, for example, a designed diffractive grating to expand a beam along two axes.

When the light guide plate 130 is formed as a single layer, the diffractive grating of the second region 132 may be formed on the same surface as a surface where the diffractive grating of the first region 131 is formed or an opposite surface to the surface. When the light guide plate 130 is formed as multiple layers, the diffractive grating of the second region 132 may be formed on the same surface as the surface where the diffractive grating of the first region 131 is formed or a different surface than the surface. Although it is described in the current embodiment of the disclosure that the second region 132 is a single region, the second region 132 may be divided into a plurality of regions. When the light guide plate 130 is formed as multiple layers, the second region 132 may include a plurality of regions formed on different layers.

The third region 133 may be positioned on a surface facing eyes of the user when the user wears the AR display device 100. For example, in FIG. 4, the third region 133 may be positioned in a second direction (an−X direction) with respect to the first region 131. The entire third region 133 or a part thereof may overlap with the second region 132. In the third region 133, an output grating array may be formed to output light propagating from the second region 132 outside the light guide plate 130, and may also serve as a pupil expansion grating. When the light guide plate 130 is formed as a single layer, the output grating array of the third region 133 may be formed on a surface of the light guide plate 130, which faces the eyes of the user, or a back surface thereof. Alternatively, when the light guide plate 130 is formed as multiple layers, the output grating array of the third region 133 may be formed on some or all of the multiple layers.

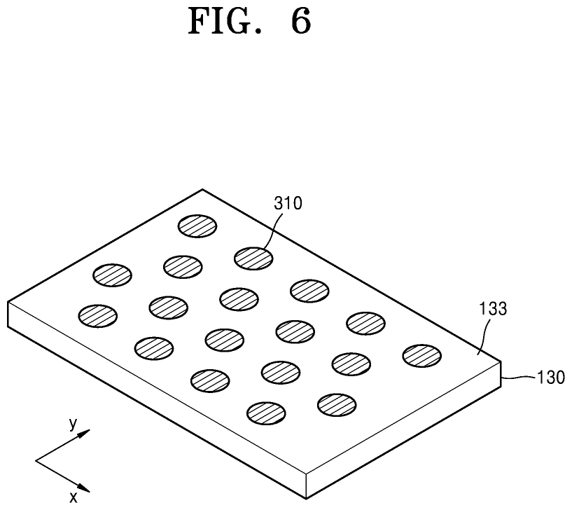

FIG. 6 shows a third region of a light guide plate according to an embodiment of the disclosure. Referring to FIG. 6, the third region 133 of the light guide plate 130 has formed therein an array of small output grating regions 310. A small output grating formed in each of the small output grating regions (small diffractive grating regions) 310 may be any one of a diffractive optical element, a surface relief grating, a hologram optical element, and a metasurface. Grating vectors of the small output gratings respectively formed in the small output grating regions 310 may be the same as or different from one another. In this case, designing may be such that a sum of grating vectors of three regions (i.e., the first region 131, the second region 132, and the third region 133 of FIG. 5) which light passes through is 0 to output incident light, thereby reducing distortion of an image.

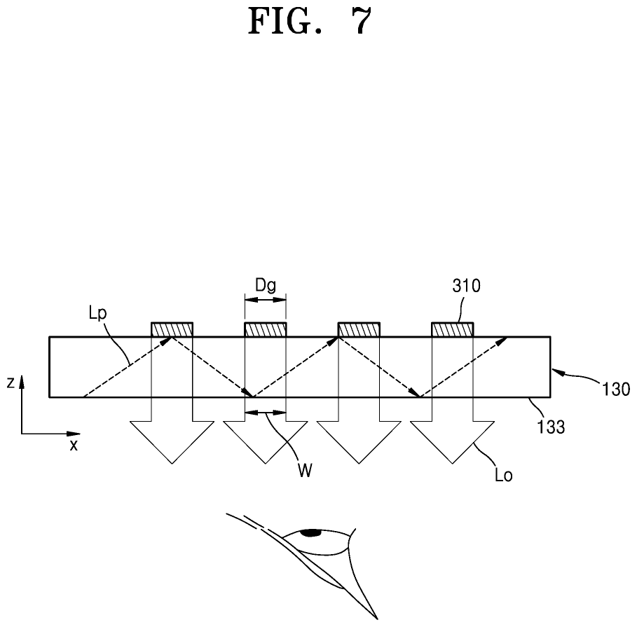

FIG. 7 illustrates light output in a third region of a light guide plate according to an embodiment of the disclosure. A light beam indicated by Lp in FIG. 7 indicates light propagating at a specific angle in the entire field of view (FoV) of an image input to the light guide plate 130. The light Lp propagating through total internal reflection (TIR) in the light guide plate 130 may be diffracted in the small output grating region 310 and output outside the light guide plate 130. In this case, a beam width W of the output light Lo may be determined by a diameter D_{g} of the small output grating region 310 and may have a relationship as below.

W≈D_{g} [Equation 1]

Such an operating principle may operate in the same manner at every angle of light incident to the light guide plate 130. Finally, each small output grating region 310 may be regarded as the optical engine 120 having a beam width of D_{g}.

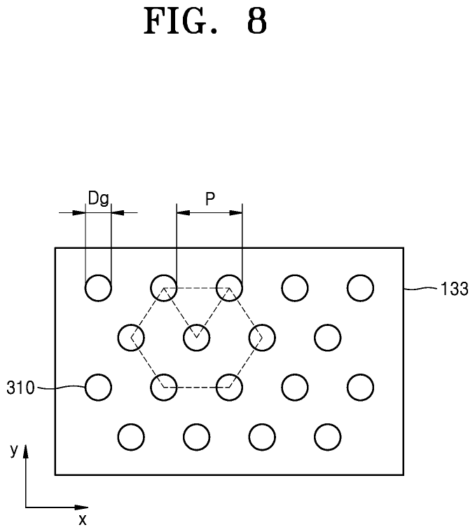

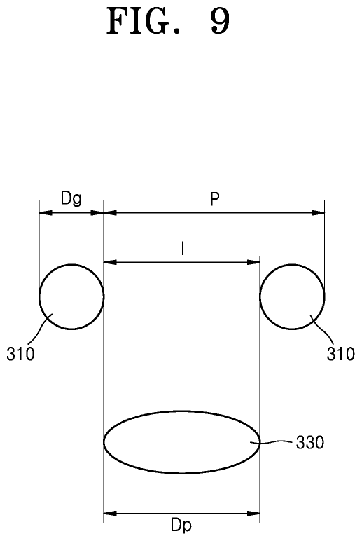

FIG. 8 illustrates arrangement of a small output grating region according to an embodiment of the disclosure, and FIG. 9 illustrates a relationship between a small output grating region and a pupil according to an embodiment of the disclosure. Referring to FIGS. 8 and 9, the diameter D_{g} of the small output grating region 310 may be less than that of a human pupil. The diameter of the human pupil is typically known as about 4 mm. Thus, the diameter D_{g} of the small output grating region 310 according to an embodiment of the disclosure may be approximately equal to or less than about 4 mm. For example, the diameter D_{g} of the small output grating region 310 may be about 2 mm.

To reduce discontinuity of the entire image formed on the pupil, an interval I between the small output grating regions 310 may be approximately equal to or less than a pupil diameter D_{P}. For example, the interval I between the small output grating regions 310 may be approximately equal to or less than about 4 mm. In other words, a pitch P of an output grating array including the small output grating regions 310 may satisfy the following mathematical relationship with the diameter D_{g} of the small output grating region 310 and the pupil diameter D_{P}.

Dₚ≤P≤D_{g}+D_{P} [Equation 2]

The pitch P of the output grating array may be uniform across the entire third region 133, without being limited thereto.

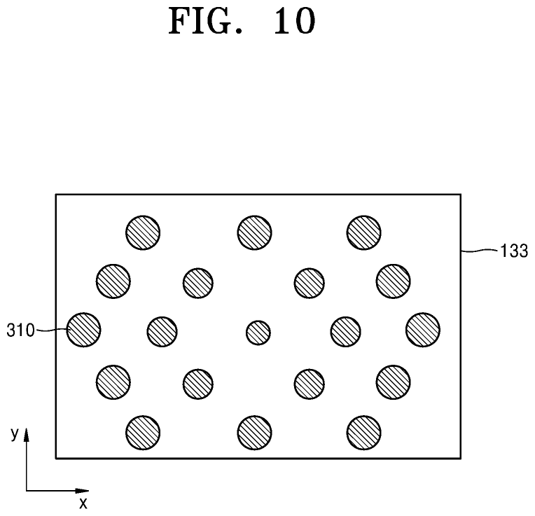

FIG. 10 illustrates arrangement of a small output grating region according to an embodiment of the disclosure. To adjust the beam width W of the image output for each position, the diameter D_{g} of each small output grating region 310 may differ. Referring to FIG. 10, the diameter D_{g} of the small output grating region 310 of the third region 133 may be greater in an edge than in a center, and the pitch P may be varied according to Equation 2.

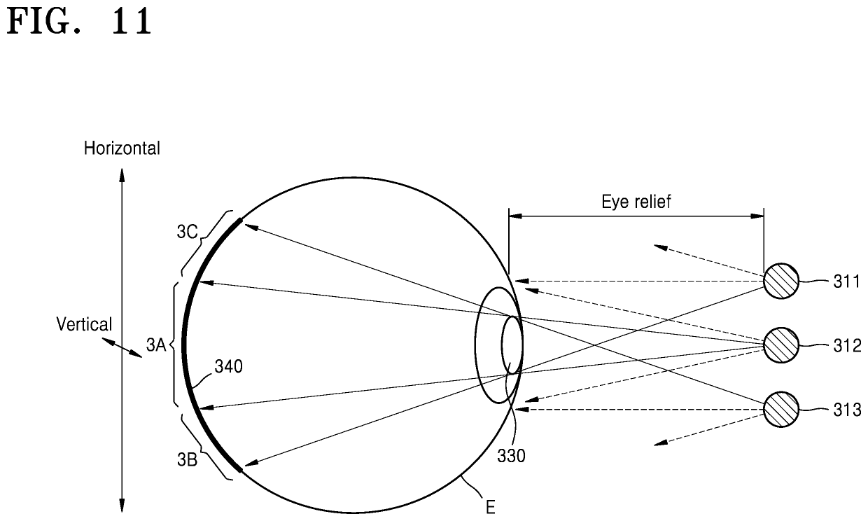

FIG. 11 illustrates a light beam emitted from a small output grating region array in a horizontal direction and reaching a retina, according to an embodiment of the disclosure. In FIG. 11, first through third small output grating regions (i.e., diffractive elements) 311, 312, and 313 may be arranged at intervals of approximately a pupil size of an eye E. Each of the first to third small output grating regions 311, 312, and 313 may operate like duplication of one optical engine 120, such that light containing the entire virtual image may be emitted from the first to third small output grating regions 311, 312, and 313. Light at some angles in the light beam emitted from the second diffractive element 312 located in front of a pupil 330 may form an FoV 3A of a center portion by passing through the pupil 330 and reaching a retina 340 of the eye E. Meanwhile, a light beam at a wider angle among light beams emitted from the first and third small output grating regions 311 and 313 located obliquely with respect to the front of the pupil 330 may reach the retina 340 of the eye E to form additional FoVs 3B and 3C in the horizontal direction. In this case, the FoV of the image reaching the retina 340 through each of the small output grating regions 311, 312, and 313 may be determined by a diameter Dₚ of the pupil 330, a diameter D_{g} of each of the small output grating regions 311, 312, and 313, and a distance between the pupil 330 and each of the small output grating regions 311, 312, and 313, i.e., an eye relief. That is, the FoV of the virtual image reaching the retina 340 may be achieved by increasing the number of small output grating regions 311, 312, and 313, which is equally applicable in the vertical direction.

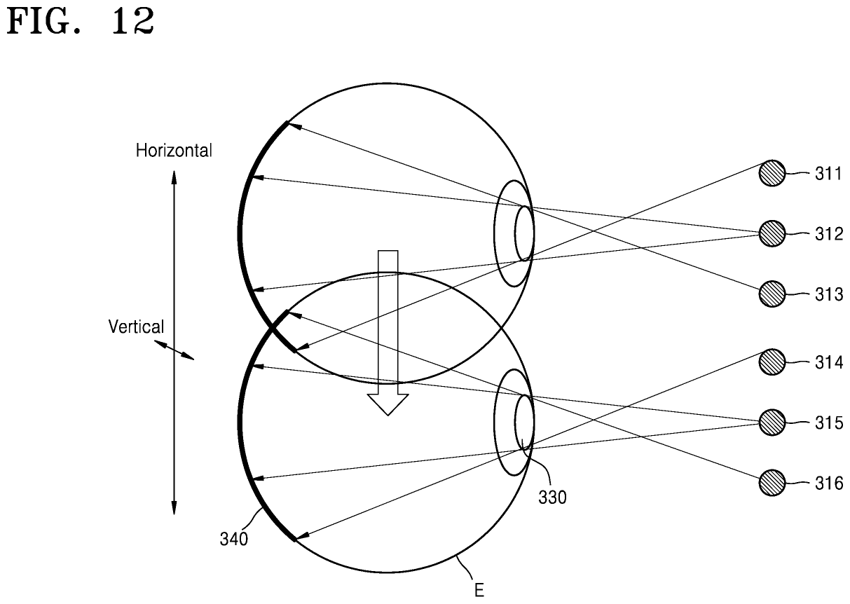

FIG. 12 illustrates a light beam emitted from a small output grating region and reaching a retina when an eye moves, according to an embodiment of the disclosure. Referring to FIG. 12, when the eye moves due to a different inter pupil distance (IPD) of a user, rotation of the eye, etc., relative positions between first through sixth small output grating regions 311, 312, 313, 314, 315, and 316 and the pupil 330 may change, but the first to sixth small output grating regions 311, 312, 313, 314, and 316 may output the same image information as an input image with an interval of a pupil size of the eye E (or a size less than the pupil size), such that the user may seamlessly see the virtual image. That is, by arranging multiple small output grating regions, a wide eye motion box may be implemented. In addition, light output at the same angle in translation of the eye (movement in the horizontal or vertical direction) may reach the same position on the retina 340, such that the virtual image may be output at the same position at all times. For example, a user having a different IPD may see a virtual image at almost the same position.

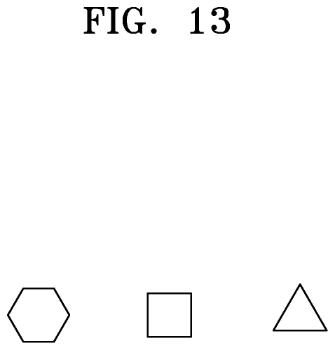

FIG. 13 illustrates various shapes of a small output grating region according to an embodiment of the disclosure. Although an appearance of a small output grating region has a circular boundary in the above-described embodiments of the disclosure, the disclosure is not limited thereto. For example, an appearance of a circular diffractive may have a boundary in a polygonal shape such as a hexagonal shape, a rectangular shape, or a triangular shape as shown in FIG. 10 for brightness uniformity of a virtual image, reduction of distortion like a double image, etc., and the shape and position of an array may change accordingly.

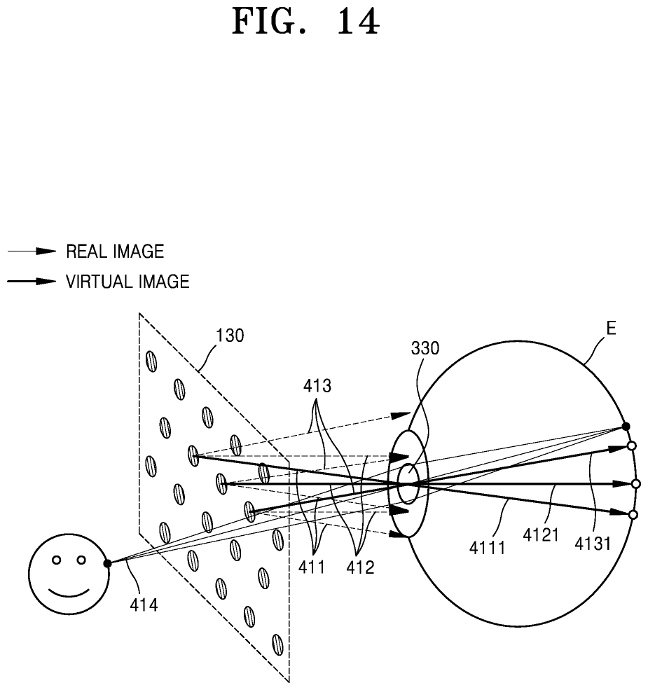

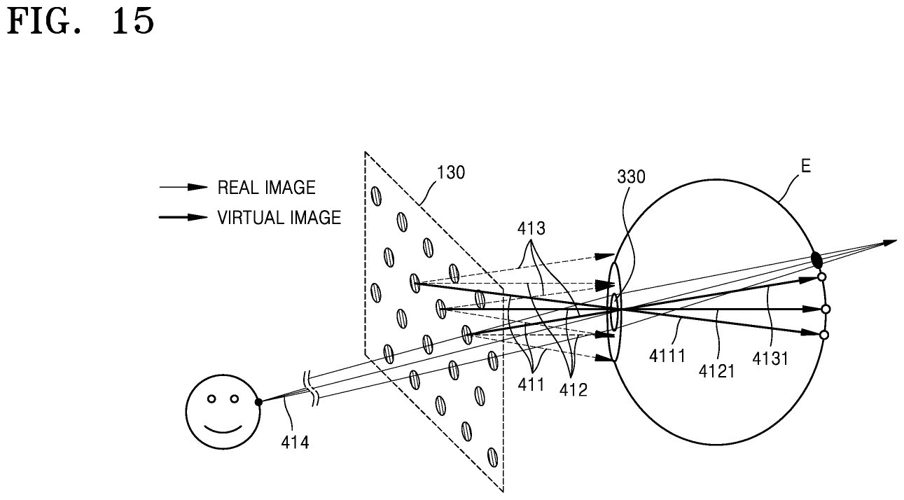

FIG. 14 illustrates an eye and light beams of a real image and a virtual image when a user looks at a short distance, and FIG. 15 illustrates an eye and light beams of a real image and a virtual image when the user looks at a long distance. In FIGS. 14 and 15, for example, a part of a virtual image emitted from small output grating regions is indicated by light beams 411, 412, and 413 of different angles (presenting different pixels). In this case, a beam width of the light beams 411, 412, and 413 emitted from the small output grating regions may be maintained less than a diameter of a pupil according to a size of the diameter of the small output grating regions. Referring to FIGS. 14 and 15, among the light beams 411, 412, and 413, light beams 4111, 4121, and 4131 suitable for an angle between the pupil 330 and each small output grating region may pass through the pupil 330 to form an image as each point on a retina regardless of change in a thickness of a crystalline lens, such that the virtual image may be in focus regardless of a gaze distance of the user. Meanwhile, light beams 414 emitted from one point of a real image are transmitted to the eye through a small output grating region without distortion, thereby forming a focus according to movement of the crystalline lens of the eye E. Light beams emitted from one point of a short-distance object are focused as one point on a retina by a crystalline lens of the user when the user looks at the short distance as shown in FIG. 14, but light beams emitted from one point of the short-distance object may not be focused as one point on the retina, blurring an image, when the user looks at the long distance as shown in FIG. 15. As such, the AR display device according to the current embodiment of the disclosure may match and maintain focuses of a real image and a virtual image without a separate active element such as a focus-tunable lens or a light shutter, and provide wide FoV and eye box. Thus, it is possible to reduce a size, power consumption, and a price of AR glasses. Moreover, the AR display device may maintain a focus at all times, thereby reducing the fatigue of the eye, caused by vergence accommodation conflict.

In addition, each circular diffractive element projects the same virtual image to form a focus at all times in spite of eye movement, and allows watching of the same image to provide a large eye box.

While the AR display device according to the disclosure has been shown and described in connection with the embodiments of the disclosure to help understanding of the disclosure, it will be apparent to those of ordinary skill in the art that modifications and variations may be made. Therefore, the true technical scope of the disclosure should be defined by the appended claims.

1. An augmented reality (AR) display device comprising:
an optical engine configured to output light of a virtual image; and
a light guide plate comprising a first region that receives the light of the virtual image, a third region that outputs the light of the virtual image, and a second region that propagates the light of the virtual image input to the first region toward the third region,
wherein a pupil expansion grating is formed in the second region to duplicate the light of the virtual image incident to the first region into a plurality of beamlets, and
in the third region, an output grating array is formed in which a plurality of small diffractive grating regions are arranged at intervals equal to or less than a first size of a pupil, wherein a diameter of each of the plurality of small diffractive grating regions is equal to or less than the first size of the pupil.

2. The AR display device of claim 1, wherein a small diffractive grating of each of the plurality of small diffractive grating regions comprises one of a diffractive optical element, a surface relief grating, a hologram optical element, or a metasurface.

3. The AR display device of claim 1, wherein each of the plurality of small diffractive grating regions comprises a circular or polygonal boundary.

4. The AR display device of claim 1, wherein a second size of each of the plurality of small diffractive grating regions is equal to or less than about 4 millimeters (mm).

5. The AR display device of claim 1, wherein the plurality of small diffractive grating regions are arranged in a hexagonal array pattern.

6. The AR display device of claim 1, wherein a small diffractive grating of each of the plurality of small diffractive grating regions comprises an identical or different vector.

7. The AR display device of claim 1, wherein an input diffractive grating is formed in the first region to couple a received light of the virtual image to the second region, and
a sum of a first grating vector of the input diffractive grating of the first region, a second grating vector of the pupil expansion grating of the second region, and a third grating vector of a small diffractive grating of the plurality of small diffractive grating regions is equal to 0.

8. The AR display device of claim 1, wherein a pitch of the output grating array is uniform.

9. The AR display device of claim 1, wherein a pitch of the output grating array is varied.

10. The AR display device of claim 1, wherein at least some of the plurality of small diffractive grating regions have different diameters.

11. The AR display device of claim 1, wherein the plurality of small diffractive grating regions have larger diameters in an edge of the third region than in a center of the third region.

12. The AR display device of claim 1, wherein at least a part of the third region overlaps with the second region.

13. The AR display device of claim 1, wherein at least a partial region of the light guide plate is formed of a transparent material to pass light of a real scene through the transparent material.

14. The AR display device of claim 1, further comprising a body having the optical engine and the light guide plate installed therein and configured to be wearable on a user.

15. The AR display device of claim 14, wherein the body comprises a glasses frame, a goggles frame, a first main body of a helmet body, and a second main body of a head mounted display (HMD).

16. The AR display device of claim 1, wherein the intervals of the plurality of small diffractive grating regions are arranged to and provide a wide eye motion box with respect to translation of eyes vertically or horizontally.

17. The AR display device of claim 1, wherein a beam width of a plurality of light beams emitted from the plurality of small diffractive grating regions is maintained at less than a diameter of a pupil according to a size of a diameter of each small diffractive grating region of the plurality of small diffractive grating regions, regardless of change in a thickness of a crystalline lens of an eye, such that a virtual image remains in focus regardless of a gaze distance of a user.

18. The AR display device of claim 4, wherein the intervals of the plurality of small diffractive grating regions are arranged to and provide a wide eye motion box with respect to translation of eyes vertically or horizontally.

19. The AR display device of claim 4, wherein a beam width of a plurality of light beams emitted from the plurality of small diffractive grating regions is maintained at less than a diameter of a pupil according to a size of a diameter of each small diffractive grating region of the plurality of small diffractive grating regions, regardless of change in a thickness of a crystalline lens of an eye, such that a virtual image remains in focus regardless of a gaze distance of a user.

20. The AR display device of claim 19, wherein a shape of each small diffractive grating tegion of the plurality of small diffractive grating regions is one of a hexagonal shape, a rectangular shape, or a triangular shape.
